(19) United States
(12) Patent Application Publication
(10) Pub. No.: US 2026/0084010 A1
(43) Pub. Date: Mar. 26, 2026

(54) PATH PLANNING METHOD FOR PUTTING ON THE GREEN AND A DEVICE

(71) Applicant: SHENZHEN MILESEEY TECHNOLOGY CO., LTD., Shenzhen (CN)

(72) Inventors: Long LUO, Shenzhen (CN); Zhi CHOU, Shenzhen (CN)

(21) Appl. No.: 18/911,490

(22) Filed: Oct. 10, 2024

(30) Foreign Application Priority Data
Sep. 23, 2024 (CN) 2024113292514

(51) Int. Cl. A63B 24/00

(52) U.S. Cl. CPC A63B 24/0021; A63B 2024/0037

(57) ABSTRACT

This application provides a path planning method for putting on the green and a device. The method includes: scanning a planned green to obtain a spatial multi-dimensional information map of the green; analyzing the spatial multi-dimensional information map to obtain an elevation information of the green; performing a target detection on the spatial multi-dimensional information map to determine positions of a golf ball and a hole in the spatial multi-dimensional information map; and generating a batting path information according to the elevation information and positions of the golf ball and hole, to complete a path planning for the green according to the batting path information.

### CROSS-REFERENCE TO RELATED APPLICATIONS

The present disclosure claims priority of the Chinese Patent application No. 2024113292514 entitled “PATH PLANNING METHOD FOR PUTTING ON THE GREEN AND A DEVICE” filed on Sep. 23, 2024, to the China National Intellectual Property Administration, the entire contents of which are incorporated herein by reference.

### FIELD

The present disclosure relates to the technical field of path planning, and in particularly to a path planning method for putting on the green and a device.

### BACKGROUND

When golfers are putting on the golf green, one way is to obtain the green terrain through visual observation and determine the optimal path for putting based on experience. Another way is to obtain the straight-line distance and slope between the ball and the hole through some simple distance measurement devices, and then roughly estimate a batting path.

Due to the complexity of the terrain on the green, in addition to the slope and distance, there are also details such as the undulations, unevenness and changes in the turf of the green. These details can have a significant impact on the ball's rollinging path, and they may not be fully captured by the human eye or simple distance measurement devices.

Therefore, there is an urgent need for an intelligent path planning method for putting on the golf green to accurately plan the path for putting on the golf green.

### SUMMARY

The present disclosure provides a path planning method for putting on the green and a device, aiming to solve the current problem that some details that have a significant impact on the ball's rollinging path, such as the slope, distance, undulations, unevenness and changes in the turf of the green, may not be fully captured by the human eye or simple distance measurement devices.

In the first aspect, the present disclosure provides a path planning method for putting on the green, applied to a spatial multi-dimensional scanning device; the method includes: scanning a planned green to obtain a spatial multi-dimensional information map of the green; analyzing the spatial multi-dimensional information map to obtain an elevation information of the green; performing a target detection on the spatial multi-dimensional information map to determine positions of a golf ball and a hole in the spatial multi-dimensional information map; and generating a batting path information according to the elevation information and positions of the golf ball and hole, to complete a path planning for the green according to the batting path information.

In an embodiment, the spatial multi-dimensional scanning device includes a structured light acquisition module and a visible light acquisition module; the scanning a planned green to obtain a spatial multi-dimensional information map of the green, includes: obtaining a structured light image of the green scanned and collected by the structured light acquisition module; obtaining a visible light image of the green scanned and collected by the visible light acquisition module; and generating the spatial multi-dimensional information map according to the structured light image and the visible light image.

In an embodiment, the spatial multi-dimensional scanning device further includes a ranging module; the generating the spatial multi-dimensional information map according to the structured light image and the visible light image, includes: obtaining a distance information of the green scanned and collected by the ranging module; and generating the spatial multi-dimensional information map according to the distance information, structured light image and visible light image.

In an embodiment, the batting path information at least includes an optimal batting path, the generating a batting path information according to the elevation information and positions of the golf ball and hole, includes: constructing a digital elevation model of the green according to the elevation information; setting the position of the golf ball as a starting point and the position of the hole as an end point in the digital elevation model; and generating the optimal batting path from the starting point to the end point in the digital elevation model according to a preset path planning algorithm.

In an embodiment, the batting path information further includes a putting strength; after the generating the optimal batting path from the starting point to the end point in the digital elevation model according to a preset path planning algorithm, further includes: obtaining a slope information and a friction coefficient corresponding to the optimal batting path in the digital elevation model; and calculating the putting strength required for the golf ball to roll along the optimal batting path in the digital elevation model according to the slope information and friction coefficient.

In an embodiment, the spatial multi-dimensional scanning device further includes a display module; the method further includes: obtaining a display indicator corresponding to the putting strength; adding the display indicator and the optimal batting path to the spatial multi-dimensional information map; and displaying the added spatial multi-dimensional information map on the display module.

In an embodiment, the generating the optimal batting path from the starting point to the end point in the digital elevation model according to a preset path planning algorithm, includes: generating an initial path from the starting point to the end point in the digital elevation model; extracting a slope information of the green in the digital elevation model; and adjusting the initial path through the slope information according to the path planning algorithm, to generate the optimal batting path.

In an embodiment, the generating the optimal batting path from the starting point to the end point in the digital elevation model according to a preset path planning algorithm, includes: generating multiple candidate paths from the starting point to the end point in the digital elevation model according to a preset path planning algorithm; obtaining a terrain information corresponding to each candidate path in the digital elevation model; calculating a path validity corresponding to each candidate path according to the terrain information; and determining the optimal batting path from the candidate paths according to the multiple path validities.

In an embodiment, after the complete a path planning for the green according to the batting path information, further includes: if detecting that the position of the golf ball has changed and a distance to the position of the hole is greater than a preset distance, obtaining a changed position of the golf ball; and updating the batting path information according to the elevation information, the position of the hole and the changed position of the golf ball.

In the second aspect, the present disclosure provides a spatial multi-dimensional scanning device, includes: a memory and a processor; the memory is configured to store a computer program; the processor is configured to execute the computer program and implement the above any path planning method.

### BRIEF DESCRIPTION OF THE DRAWINGS

In order to clearly illustrate the technical solutions in the embodiments of this application, the following will briefly introduce the drawings used in the description of the embodiments. Apparently, the drawings in the following description are some embodiments of this application. For those of ordinary skill in the art, without making any creative efforts, other drawings can be obtained based on these drawings.

FIG. 1 is a schematic flowchart of a path planning method for putting on the green provided in an embodiment of this application.

FIG. 2 is a schematic diagram of the digital elevation model provided in an embodiment of this application.

FIG. 3 is a schematic diagram of the optimal batting path provided in an embodiment of this application.

FIG. 4 is a schematic diagram of the optimal batting path and putting strength provided in an embodiment of this application.

FIG. 5 is a schematic structural diagram of a path planning apparatus provided in an embodiment of this application.

FIG. 6 is a schematic structural diagram of a spatial multi-dimensional scanning device provided in an embodiment of this application.

### DETAILED DESCRIPTION

The technical solution of embodiments of this application is clearly and completely described in detail in connection with the accompanying drawings. Described embodiments are some embodiments of this application, not all embodiments. Based on embodiments of this application, all other embodiments obtained by those of ordinary skill in the art without creative efforts are within the scope of this application.

The following provides explanations for some of the proprietary nouns that appear in the embodiments of this application.

1, Putting on the green refers to putting the golf ball into the hole on the green. The green is a special area on the golf course. The terrain of the green may have various slopes and undulations, which can affect the rolling trajectory of the ball. Golfers need to adjust the putting strength and direction according to the changes in the terrain. The grass on the green is usually mowed very short, but the condition of the grass may vary from one course to another, which can also affect the ball's rolling. Golfers need to have some adaptability to different grass conditions. Putting on the green plays a crucial role in golf. Accurate putting can help players reduce the number of strokes on the green and improve their competition performance. Mastering the skills of putting requires continuous practice and experience accumulation.

2, The spatial multi-dimensional scanning device refers to a scanner which can obtain spatial multi-dimensional information of the green. Specifically, the device can capture three-dimensional (3D) or multi-dimensional (such as time changes or other dimensions) data of the green with high precision, and generate a detailed spatial model for subsequent analysis and path planning.

3, The spatial multi-dimensional information map refers to a graphical representation of data obtained from the spatial multi-dimensional scanning device, such as laser scanners, structured light scanners, etc. The information map contains detailed spatial information of the green, not just the three-dimensional surface structure, but also potentially includes data from other dimensions (for example, in three-dimension, it can be referred to as a 3D topographic map, and embodiments of this application do not limit the dimensions of the spatial multi-dimensional information map).

The spatial multi-dimensional information map typically includes three-dimensional point cloud data, which represent the three-dimensional coordinates (X, Y, Z) of every point on the green's surface. Through these points, a detailed three-dimensional model of the green can be constructed.

In some advanced scanning technologies, the spatial multi-dimensional information map may also include information from other dimensions, such as:

Time dimension: recording the state changes of the green at different points in time.

Light intensity: recording the lighting conditions in different areas.

Temperature or humidity: providing information on the environmental conditions of the green's surface.

Through software tools, the spatial multi-dimensional information map can be visualized to display the detailed surface and structural features of the green. This information map can help users better understand and analyze the terrain of the green.

4, The elevation information refers to the height data of every point on the green's surface. It is extracted from the spatial multi-dimensional information map and describes the undulations of the green's terrain.

The elevation information includes the height values of every point on the green relative to a certain reference surface. These height values can be either absolute heights (relative to sea level) or relative heights (relative to a reference point). Through the elevation information, the slope of the green can be calculated, wherein the slope includes the magnitude and direction of the slope. This is very important for the path planning for putting. Because the way the ball rolls varies in areas with different slopes. The elevation information can help identify topographical features on the green, such as hills and ravines, which will affect the rolling trajectory of the ball during putting.

5, The digital elevation model is a physical ground model that represents the elevation of the ground surface in an ordered array of numerical values. It is a branch of the digital terrain model (DTM), and various other terrain characteristic values can be derived from it. Generally, The DTM is considered to be a spatial distribution that describes a linear and nonlinear combination of various topographic factors, including elevation, slope, aspect, and slope change rate. The DEM is a zero-order, single digital terrain model, and other topographic characteristics such as slope, aspect, and slope change rate can be derived from the basic of the DEM.

The following provides a detailed description of some embodiments of this application with the accompanying drawings. It should be noted that, in no conflicting situations, the embodiments and features within the embodiments described below can be combined with each other.

When golfers are putting on the green, one way is to obtain the green terrain through visual observation and determine the optimal putting path based on experience. Another way is to obtain the straight-line distance and slope between the ball and the hole through some simple distance measurement devices, and then roughly estimate a batting path.

Due to the complexity of the terrain on the green, in addition to the slope and distance, there are also details such as the undulations, unevenness, and changes in the turf of the green. These details can have a significant impact on the ball's rolling path, and they may not be fully captured by the human eye or simple distance measurement devices.

Therefore, there is an urgent need for an intelligent path planning method for putting on the golf green to accurately plan the putting path on the golf green.

Please refer to FIG. 1, FIG. 1 is a schematic flowchart of a path planning method for putting on the green provided in an embodiment of this application. The method is applied to a spatial multi-dimensional scanning device. As shown in FIG. 1, the method includes the following steps.

In step 101, scan a planned green to obtain a spatial multi-dimensional information map of the green.

In an embodiment, the method conducts a comprehensive scan of the green by using the spatial multi-dimensional scanning device (such as one or more of a laser scanner, a structured light scanner, a monocular/binocular camera module, and a depth camera module), to record a large amount of point cloud data of the green's surface. Each point contains coordinate information of the X-axis, Y-axis and Z-axis. In addition to spatial coordinates, it may also include data in other dimensions, such as surface reflectivity, temperature or humidity. The spatial multi-dimensional scanning device performs preliminary processing on the raw scanning data, which includes noise removal, data alignment and registration. The processed data is converted into a visualized spatial multi-dimensional information map of the green, which is typically a high-resolution multi-dimensional model or a digital elevation model (DEM).

In an embodiment, the spatial multi-dimensional scanning device includes a structured light acquisition module and a visible light acquisition module; the scanning a planned green to obtain a spatial multi-dimensional information map of the green, includes: obtaining a structured light image of the green scanned and collected by the structured light acquisition module; obtaining a visible light image of the green scanned and collected by the visible light acquisition module; and generating the spatial multi-dimensional information map according to the structured light image and the visible light image.

It conducts a scan of the green by using the structured light acquisition module, to obtain the structured light image corresponding to the three-dimensional shape information of the green's surface. The structured light technology generates high-precision structured light images by projecting grating patterns and analyzing the deformed grating patterns. At the same time, the visible light acquisition module is configured to obtain the visible light image of the green, that is, the color, texture and visual features of the green's surface. By fusing the data of the structured light image and visible light image and combining three-dimensional structure information with surface visual information, a more complete spatial multi-dimensional information map is generated. Through the fusion of structured light and visible light, the geometric and visual features of the green can be obtained more comprehensively and accurately, which provides a basis for a precise path planning.

In an embodiment, the spatial multi-dimensional scanning device further includes a ranging module; the generating the spatial multi-dimensional information map according to the structured light image and the visible light image, includes: obtaining a distance information of the green scanned and collected by the ranging module; and generating the spatial multi-dimensional information map according to the distance information, structured light image and visible light image. The distance information in the final spatial multi-dimensional information map can be more accurate by combining with devices such as a light laser detection and ranging (LiDAR) or other ranging modules with distance measurement functions, which ensures the accuracy of the path planning and provides precise data for functions such as analysis of strength.

It should be noted that, the spatial multi-dimensional scanning device further includes a binocular/multi-eye camera module and a depth camera module. Furthermore, RGB-D images of the green collected by the depth camera module can be used to further enrich the content of the spatial multi-dimensional information map. Therefore, the embodiments of this application do not limit the composition of the spatial multi-dimensional scanning device.

In an embodiment, the spatial multi-dimensional scanning device includes 3D scanning/imaging modules, image processors, touch screens, batteries, buttons, etc. The device can be handheld or mounted on a tripod. It can be carried and used by the golfer, used with the assistance of a caddie, or fixedly installed on the side of the green training ground. The embodiments of this application do not limit the position of the spatial multi-dimensional scanning device. The device can face the golfer, the golf course or both simultaneously.

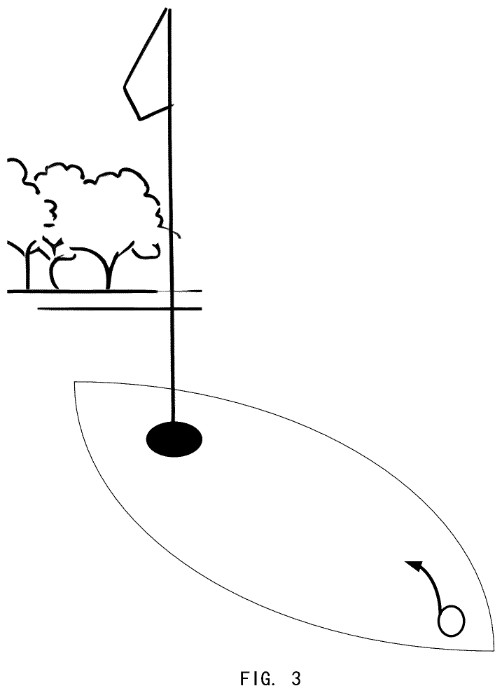

In an embodiment, when the spatial multi-dimensional scanning device is handheld to use, the user can perform a 3D scanning/imaging operation on the local space between the current position of the golf ball and position of the hole (as shown in FIG. 3), to instantly obtain a local topographic map on the screen and obtain batting suggestions from the golf ball to the hole (direction and strength) without the need to scan the entire green. The spatial multi-dimensional scanning device can also be mounted on a tripod and fixedly placed on the side of the green. After initially obtaining the terrain information of the green, it can dynamically track the new landing point of the golf ball and instantly update and plan for a new batting path.

It should be noted that, in some embodiments, when the spatial multi-dimensional scanning device is placed facing the golf course, it can be combined with wireless networks, mobile phones or PADs, APP to display, which provides a more intuitive presentation for the golfers. When the spatial multi-dimensional scanning device is placed facing the golfer, it can also be integrated with a 3D photography device such as a rangefinder telescope with the function of displaying on an external screen, local photography (multi-dimensional photos) function, path planning function, etc.

In an embodiment, the spatial multi-dimensional scanning device extracts height data from the spatial multi-dimensional information map, typically by using specialized image processing algorithms or geographic information system (GIS) tools. The extracted height data is then converted into a continuous elevation model, such as a digital elevation model (DEM) or a triangulated irregular network (TIN). For areas with sparse data, interpolation algorithms such as Kriging or inverse distance weighting are used to estimate elevation values. And then the slope and aspect of the green's surface are calculated, which is crucial for subsequent path planning. Additionally, the method provided can also perform accuracy checks on the generated elevation information to ensure its precision and reliability.

In step 103, perform a target detection on the spatial multi-dimensional information map to determine positions of a golf ball and a hole in the spatial multi-dimensional information map.

In an embodiment, the spatial multi-dimensional scanning device segments the spatial multi-dimensional information map into different areas to identify specific targets. It extracts features of the golf ball and hole, wherein the features include the shape, size and color (the hole can be identified by markers such as the flagstick). Machine learning or deep learning algorithms (such as convolutional neural networks (CNN)) are used to identify and locate the golf ball and hole, thereby determining precise coordinates of the golf ball and hole within the spatial multi-dimensional information map. The accuracy of the target detection is ensured through multiple detections or other verification methods.

In some embodiments, performing a target detection on the spatial multi-dimensional information map to determine positions of a golf ball and a hole in the spatial multi-dimensional information map, includes the following steps.

In step 103a, perform a preliminary detection in the spatial multi-dimensional information map according to the color feature of the golf ball and hole. Then identifying the ball and hole from extracted color regions according to the shape feature (such as the round shape of the golf ball and the edge contour of the hole).

In step 103b, collect and annotate a sufficient number of golf green image datasets, wherein the golf green image dataset includes images of the golf ball and hole under different environments, lighting conditions, and angles.

In step 103c, use an object detection algorithm (such as YOLO, Faster R-CNN or SSD) for training. Adjust model parameters to improve detection accuracy through backpropagation and multiple iterations.

In step 103d, input the constructed spatial multi-dimensional information map into the trained object detection model. The model will output bounding boxes that include position information of the golf ball and hole.

In step 103e, classify the detected bounding boxes to determine the positions of the golf ball and hole respectively. Enhancing the accuracy of recognition by using multi-perspective and multi-frame detection. Conduct a comprehensive analysis by combining different angles and multi-frame results to reduce false positives and false negatives.

In step 103f, perform a secondary confirmation according to the unique physical features of the golf ball and hole (such as size ratio and surrounding environment). The golf ball generally has a fixed diameter of about 42.67 millimeters, while the diameter of the hole is fixed at 108 millimeters, and the further confirmation is made by comparing these known sizes.

In step 103g, map the coordinates of the detected 2D image into a multi-dimensional (such as 3D) coordinate system through perspective transformation and depth information, to obtain the precise positions of the golf ball and the hole.

In an embodiment, after step 103g, it further includes the following steps.

In step 103h, correct the distortion and perspective errors of the image acquisition device through algorithms to ensure the accuracy of the converted multi-dimensional coordinates. Finally, generating accurate positions of the golf ball and hole in the spatial multi-dimensional information map, and outputting them. Wherein the positions serve as basic data for subsequent path planning.

In step 103i, in a simulated environment or actual field, verify the detection results of the algorithms to ensure that the position detection of the golf ball and hole is accurate and reliable. According to the verification results, adjusting and optimizing the model and algorithms to further improve the accuracy of the detection.

In step 104, generate a batting path information according to the elevation information and positions of the golf ball and hole, to complete a path planning for the green according to the batting path information.

In an embodiment, this application establishes a physical model for the golf ball rolling on the green, taking into account factors such as gravity, friction, and slope. Based on the principles of fluid mechanics, the physical model simulates the motion trajectory of the ball in different directions. The path planning algorithm (such as the A* algorithm and RRT algorithm) is used to generate possible batting paths. Through multiple iterations and optimizations, the best batting path is selected. The method can also visualize the best batting path information, which makes it easy for users to understand and apply. The method generates specific batting parameters, such as the direction and force of the batting, to guide the actual putting motion. The method uses various technologies including spatial scanning technology, image processing technology, machine learning technology, and physical simulation technology, aiming to provide an accurate path planning solution for putting on the green and improve the precision and efficiency of the golfer's putting.

In some embodiments, the batting path information at least includes an optimal batting path, the generating a batting path information according to the elevation information and positions of the golf ball and hole, includes: constructing a digital elevation model of the green according to the elevation information; setting the position of the golf ball as a starting point and the position of the hole as an end point in the digital elevation model; and generating the optimal batting path from the starting point to the end point in the digital elevation model according to a preset path planning algorithm.

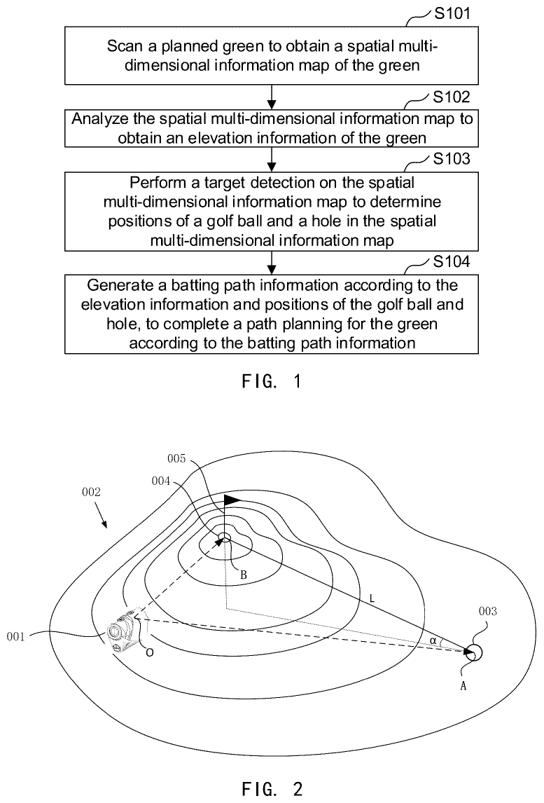

As shown in FIG. 2, the method constructs a digital elevation model (DEM) of the green's terrain according to the elevation information of the green. And it marks the positions of the golf ball and hole as the starting point and the end point (in FIG. 2, “001” represents the spatial multi-dimensional scanning device, “002” represents the digital elevation model, “003” represents the golf ball, “004” represents the hole, “005” represents the flagstick, “A” is the starting point, “B” is the end point, “O” is the position of the spatial multi-dimensional scanning device, and “L” is the straight-line distance between “A” and “B” measured by the spatial multi-dimensional scanning device). Additionally, the starting point and end point can be set manually by the user (at this time, it is not necessary to scan the positions of the golf ball and hole, or they can be scanned for the user to choose). The method calculates the slope (including the magnitude and direction of the slope) of each point on the green's surface through the elevation model. Features such as steep slope areas, ravines and obstacles can affect the path and force for putting. By selecting an appropriate path planning algorithm (such as an optimized A* algorithm, a Dijkstra's algorithm, or a shortest path algorithm based on physical simulation), the optimal path from the golf ball's position to the hole's position can be found.

The method sets a straight-line path from the position of the golf ball to the position of the hole. According to the elevation information, it simulates the motion trajectory of the ball combining with the principles of fluid mechanics, and adjusts the path through multiple iterations. By taking into account factors such as the slope of the terrain, rolling resistance and others, the optimal path can be found.

In an embodiment, the batting path information further includes a putting strength; after the generating the optimal batting path from the starting point to the end point in the digital elevation model according to a preset path planning algorithm, further includes: obtaining a slope information and a friction coefficient corresponding to the optimal batting path in the digital elevation model; and calculating the putting strength required for the golf ball to roll along the optimal batting path in the digital elevation model according to the slope information and friction coefficient.

The method establishes a motion model of the ball based on the principles of energy and dynamics in physics. By combining the law of conservation of energy, friction, and acceleration formulas, and considering the friction and the changes in slope of the green's surface, the rolling of the golf ball on the green is simulated. The optimal path is divided into segments according to terrain features, and the required putting strength is calculated for each segment. For example, when going uphill, more strength is needed, and the steeper the slope, the greater the strength needed; when going downhill, less strength is needed, and the steeper the slope, the less the strength needed. The strength is adjusted according to the friction coefficient of different areas. For each segment, the resultant force F can be calculated by using the formula: F=m*g¿hₛₗₒₚₑ+f. Wherein “f” is the friction, “g” is the proportionality coefficient, “m” is the mass of the golf ball, and “hₛₗₒₚₑ” is the height of the slope corresponding to each segment. The overall optimal putting strength can then be calculated based on the total length of the path and the resultant force of each segment. This ensures that the generated path and strength are optimally matched.

The method can also perform dynamic simulation and correction of the putting strength. By simulating multiple batting paths with different strengths and analyzing the effect of each path, the path with the best effect can be selected. Based on the simulation results, the batting strength is corrected to better match the actual terrain features.

In some embodiments, the spatial multi-dimensional scanning device further includes a display module; the method further includes: obtaining a display indicator corresponding to the putting strength; adding the display indicator and the optimal batting path to the spatial multi-dimensional information map; and displaying the added spatial multi-dimensional information map on the display module.

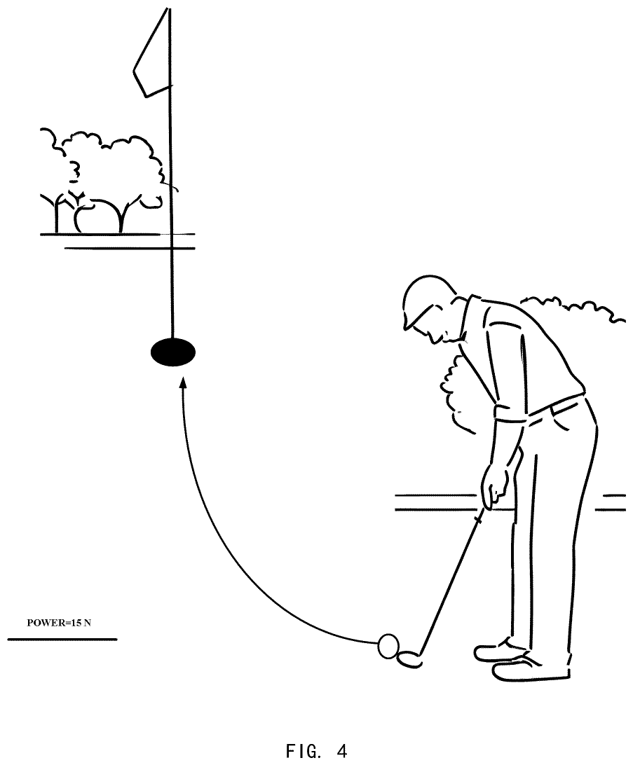

Please refer to FIG. 3 and FIG. 4 (the method can perform local scanning and display local batting suggestions according to requirements, as shown in FIG. 3, or display corresponding suggestions under the global terrain of the green, as shown in FIG. 4). The arrow can be used as a display indicator pointing to the optimal batting path. The length of the arrow (or, as shown in FIG. 4, a corresponding strength bar can be generated) corresponds to the batting strength, which displayed in the spatial multi-dimensional information map. The batting strength can be shown on the display module (as 15N in FIG. 4). This allows golfers to view the current optimal batting path and strength in real time. The combination of the display indicator and the optimal batting path can also take any other form, which is adjusted according to display requirements, and is not limited in the embodiment of this application.

As shown in FIG. 4, when multiple golf balls are involved, golfers can manually specify the batting path planning for a particular ball or multiple balls at the same time.

In some embodiments, the generating the optimal batting path from the starting point to the end point in the digital elevation model according to a preset path planning algorithm, includes: generating an initial path from the starting point to the end point in the digital elevation model; extracting a slope information of the green in the digital elevation model; and adjusting the initial path through the slope information according to the path planning algorithm, to generate the optimal batting path.

Set the initial path, typically a straight-line path, from the golf ball's position directly to the hole's position. The initial path is corrected based on the elevation information. Considering the impact of slope, the motion trajectory of the ball is simulated, and the path is adjusted through multiple iterations. The ball's rolling on different paths is simulated. According to the slope information of the green, perform a global optimization through path search algorithms to find the optimal batting path. The optimal batting path can be represented as a comprehensive optimum under factors such as the rolling distance of the ball, resistance consumption, and the difficulty of the path after considering the changes in slope.

In some embodiments, the generating the optimal batting path from the starting point to the end point in the digital elevation model according to a preset path planning algorithm, includes: generating multiple candidate paths from the starting point to the end point in the digital elevation model according to a preset path planning algorithm; obtaining a terrain information corresponding to each candidate path in the digital elevation model; calculating a path validity corresponding to each candidate path according to the terrain information; and determining the optimal batting path from the candidate paths according to the multiple path validities.

By generating multiple candidate paths for parallel evaluation. Perform the simulation on each candidate path and evaluate the rolling effect of the ball on these paths based on factors such as the length of the path, rolling resistance and reliability. By setting up a path validity calculation function, score the candidate paths. Select the path with the highest score as the optimal batting path. Thereby ensuring that the optimal batting path can be obtained in real time.

In some embodiments, after the complete a path planning for the green according to the batting path information, further includes: if detecting that the position of the golf ball has changed and a distance to the position of the hole is greater than a preset distance, obtaining a changed position of the golf ball; and updating the batting path information according to the elevation information, the position of the hole and the changed position of the golf ball. When the golfer fails to putt the ball into the hole in one attempt based on the batting path information, the method can update the batting path information in real time according to the changed position of the golf ball. This ensures that the method provides users with the optimal batting path planning in real time.

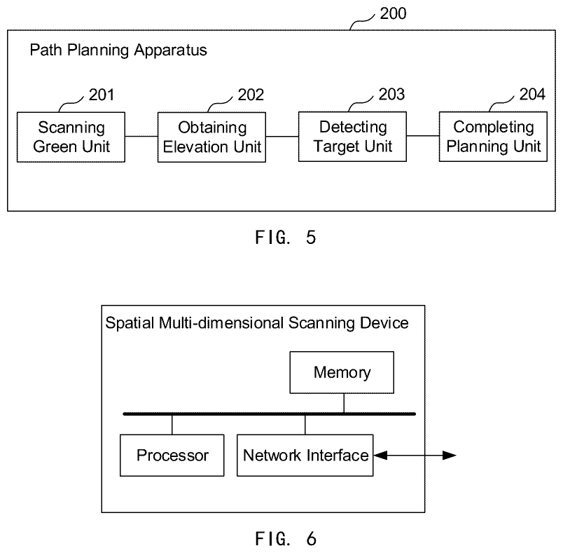

In order to implement methods in the aforementioned embodiments, to achieve the corresponding functions and technical effects. Refer to FIG. 5, FIG. 5 is a schematic structural diagram of a path planning apparatus 200 provided in an embodiment of this application. The path planning apparatus 200 is applied to a spatial multi-dimensional scanning device. For ease of description, only parts related to this embodiment are shown. The path planning apparatus 200 provided in the embodiment of this application includes the following units.

Scanning green unit 201, configured to scan a planned green to obtain a spatial multi-dimensional information map of the green.

Obtaining elevation unit 202, configured to analyze the spatial multi-dimensional information map to obtain an elevation information of the green.

Detecting target unit 203, configured to perform a target detection on the spatial multi-dimensional information map to determine positions of a golf ball and a hole in the spatial multi-dimensional information map.

Completing planning unit 204, configured to generate a batting path information according to the elevation information and positions of the golf ball and hole, to complete a path planning for the green according to the batting path information.

The aforementioned path planning apparatus 200 can implement the path planning methods of the aforementioned embodiments. The optional features in the path planning methods of the aforementioned embodiments are also applicable to this embodiment, and will not be detailed further here. The remaining content of this embodiment can refer to the content of the path planning methods of the aforementioned embodiments, and will not be detailed in this embodiment.

Please refer to FIG. 6, FIG. 6 is a schematic structural diagram of a spatial multi-dimensional scanning device provided in an embodiment of this application. The spatial multi-dimensional scanning device includes a processor, a memory and a network interface connected via a device bus, wherein the memory may include a storage medium and at least one internal memory.

The storage medium is configured to store an operating system and a computer program. The computer program includes program instructions. When these program instructions are executed, the processor performs any one of path planning methods.

The processor is configured to provide computing and controlling, supporting the operation of the entire spatial multi-dimensional scanning device.

The internal memory provides an environment for the execution of the computer program stored in non-volatile storage medium. When the processor executes the computer program, the processor performs any one of path planning methods.

The network interface is used for network communication, such as sending assigned tasks, etc. It is understood by those skilled in the art that the structures shown in FIG. 6 is merely some of the structures related to this application and do not constitute a limitation on the terminal which this application is applied. The specific spatial multi-dimensional scanning device can include more or fewer components than those shown in the figure, or combinations of certain components, or have a different component layout.

It should be understood that, the processor can be a central processing unit (CPU), and the processor can also be other general-purpose processors, a digital signal processor (DSP), an application specific integrated circuits (ASIC), a field-programmable gate array (FPGA), or other programmable logic devices, discrete gate or transistor logic devices, discrete hardware components, etc. Wherein the general-purpose processor can be a micro-processor, or be any conventional processor, etc.

In an embodiment, the processor is configured to invoke the computer program stored in the memory to perform the following steps: scanning a planned green to obtain a spatial multi-dimensional information map of the green; analyzing the spatial multi-dimensional information map to obtain an elevation information of the green; performing a target detection on the spatial multi-dimensional information map to determine positions of a golf ball and a hole in the spatial multi-dimensional information map; and generating a batting path information according to the elevation information and positions of the golf ball and hole, to complete a path planning for the green according to the batting path information.

In an embodiment, the spatial multi-dimensional scanning device includes a structured light acquisition module and a visible light acquisition module; the scanning a planned green to obtain a spatial multi-dimensional information map of the green, includes: obtaining a structured light image of the green scanned and collected by the structured light acquisition module; obtaining a visible light image of the green scanned and collected by the visible light acquisition module; and generating the spatial multi-dimensional information map according to the structured light image and the visible light image.

In an embodiment, the spatial multi-dimensional scanning device further includes a ranging module; the generating the spatial multi-dimensional information map according to the structured light image and the visible light image, includes: obtaining a distance information of the green scanned and collected by the ranging module; and generating the spatial multi-dimensional information map according to the distance information, structured light image and visible light image.

In an embodiment, the batting path information at least includes an optimal batting path, the generating a batting path information according to the elevation information and positions of the golf ball and hole, includes: constructing a digital elevation model of the green according to the elevation information; setting the position of the golf ball as a starting point and the position of the hole as en end point in the digital elevation model; and generating the optimal batting path from the starting point to the end point in the digital elevation model according to a preset path planning algorithm.

In an embodiment, the batting path information further includes a putting strength; after the generating the optimal batting path from the starting point to the end point in the digital elevation model according to a preset path planning algorithm, further includes: obtaining a slope information and a friction coefficient corresponding to the optimal batting path in the digital elevation model; and calculating the putting strength required for the golf ball to roll along the optimal batting path in the digital elevation model according to the slope information and friction coefficient.

In an embodiment, the spatial multi-dimensional scanning device further includes a display module; the method further includes: obtaining a display indicator corresponding to the putting strength; adding the display indicator and the optimal batting path to the spatial multi-dimensional information map; and displaying the added spatial multi-dimensional information map on the display module.

In an embodiment, the generating the optimal batting path from the starting point to the end point in the digital elevation model according to a preset path planning algorithm, includes: generating an initial path from the starting point to the end point in the digital elevation model; extracting a slope information of the green in the digital elevation model; and adjusting the initial path through the slope information according to the path planning algorithm, to generate the optimal batting path.

In an embodiment, the generating the optimal batting path from the starting point to the end point in the digital elevation model according to a preset path planning algorithm, includes: generating multiple candidate paths from the starting point to the end point in the digital elevation model according to a preset path planning algorithm; obtaining a terrain information corresponding to each candidate path in the digital elevation model; calculating a path validity corresponding to each candidate path according to the terrain information; and determining the optimal batting path from the candidate paths according to the multiple path validities.

In an embodiment, after the complete a path planning for the green according to the batting path information, further includes: if detecting that the position of the golf ball has changed and a distance to the position of the hole is greater than a preset distance, obtaining a changed position of the golf ball; and updating the batting path information according to the elevation information, the position of the hole and the changed position of the golf ball.

An embodiment of this application further provides a computer-readable storage medium. The computer-readable storage medium stores a computer program. The computer program includes program instructions. The processor executes these program instructions to perform any one of path planning methods provided by the embodiments of this application.

The computer-readable storage medium can be an internal storage unit of the aforementioned spatial multi-dimensional scanning device, such as the hard disk drive or memory of the spatial multi-dimensional scanning device. The computer-readable storage medium can also be an external storage device of the spatial multi-dimensional scanning device, such as a pluggable hard disk drive, a smart media card (SMC), a secure digital (SD) card, a flash card equipped on the spatial multi-dimensional scanning device.

The aforementioned descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A path planning method for putting on the green, applied to a spatial multi-dimensional scanning device, comprising:
scanning a planned green to obtain a spatial multi-dimensional information map of the green;
analyzing the spatial multi-dimensional information map to obtain an elevation information of the green;
performing a target detection on the spatial multi-dimensional information map to determine positions of a golf ball and a hole in the spatial multi-dimensional information map; and
generating a batting path information according to the elevation information and positions of the golf ball and hole, to complete a path planning for the green according to the batting path information.

2. The method according to claim 1, wherein the spatial multi-dimensional scanning device comprises a structured light acquisition module and a visible light acquisition module; the scanning a planned green to obtain a spatial multi-dimensional information map of the green comprises:
obtaining a structured light image of the green scanned and collected by the structured light acquisition module;
obtaining a visible light image of the green scanned and collected by the visible light acquisition module; and
generating the spatial multi-dimensional information map according to the structured light image and the visible light image.

3. The method according to claim 2, wherein the spatial multi-dimensional scanning device further comprises a ranging module; the generating the spatial multi-dimensional information map according to the structured light image and the visible light image comprises:
obtaining a distance information of the green scanned and collected by the ranging module; and
generating the spatial multi-dimensional information map according to the distance information, structured light image and visible light image.

4. The method according to claim 1, wherein the batting path information at least comprises an optimal batting path, the generating a batting path information according to the elevation information and positions of the golf ball and hole comprises:
constructing a digital elevation model of the green according to the elevation information;
setting the position of the golf ball as a starting point and the position of the hole as an end point in the digital elevation model; and
generating the optimal batting path from the starting point to the end point in the digital elevation model according to a preset path planning algorithm.

5. The method according to claim 4, wherein the batting path information further comprises a putting strength; after the generating the optimal batting path from the starting point to the end point in the digital elevation model according to a preset path planning algorithm, the method further comprises:
obtaining a slope information and a friction coefficient corresponding to the optimal batting path in the digital elevation model; and
calculating the putting strength required for the golf ball to roll along the optimal batting path in the digital elevation model according to the slope information and friction coefficient.

6. The method according to claim 5, wherein the spatial multi-dimensional scanning device further comprises a display module; the method further comprises:
obtaining a display indicator corresponding to the putting strength;
adding the display indicator and the optimal batting path to the spatial multi-dimensional information map; and
displaying the added spatial multi-dimensional information map on the display module.

7. The method according to claim 4, wherein the generating the optimal batting path from the starting point to the end point in the digital elevation model according to a preset path planning algorithm comprises:
generating an initial path from the starting point to the end point in the digital elevation model;
extracting a slope information of the green in the digital elevation model; and
adjusting the initial path through the slope information according to the path planning algorithm, to generate the optimal batting path.

8. The method according to claim 4, wherein the generating the optimal batting path from the starting point to the end point in the digital elevation model according to a preset path planning algorithm comprises:
generating multiple candidate paths from the starting point to the end point in the digital elevation model according to a preset path planning algorithm;
obtaining a terrain information corresponding to each candidate path in the digital elevation model;
calculating a path validity corresponding to each candidate path according to the terrain information; and
determining the optimal batting path from the candidate paths according to the multiple path validities.

9. The method according to claim 1, wherein after the complete a path planning for the green according to the batting path information, the method further comprises:
if detecting that the position of the golf ball has changed and a distance to the position of the hole is greater than a preset distance, obtaining a changed position of the golf ball; and
updating the batting path information according to the elevation information, the position of the hole and the changed position of the golf ball.

10. The method according to claim 1, wherein the scanning a planned green to obtain a spatial multi-dimensional information map of the green comprises:
scanning a planned green through the spatial multi-dimensional scanning device, and performing preliminary processing to obtain a processed data; and
converting the processed data into a spatial multi-dimensional information map of the green.

11. The method according to claim 1, wherein the performing a target detection on the spatial multi-dimensional information map to determine positions of a golf ball and a hole in the spatial multi-dimensional information map comprises:
segmenting the spatial multi-dimensional information map into different areas to identify specific targets;
extracting features of a golf ball and a hole; and
identifying the golf ball and hole, according to the features, and determining positions of the golf ball and hole.

12. The method according to claim 11, wherein the features comprise a color feature and a shape feature;
the identifying the golf ball and hole according to the features comprises:
performing a preliminary detection in the spatial multi-dimensional information map to obtain color regions according to the color feature of the golf ball and hole; and
identifying the ball and hole from the color regions according to the shape feature of the golf ball and hole.

13. The method according to claim 4, wherein the path planning algorithm comprises an A* algorithm, a Dijkstra's algorithm or a shortest path algorithm.

14. The method according to claim 1, wherein the performing a target detection on the spatial multi-dimensional information map to determine positions of a golf ball and a hole in the spatial multi-dimensional information map comprises:
collecting and annotating golf green image datasets;
using an object detection algorithm for model training;
inputting the spatial multi-dimensional information map into the trained object detection model, wherein the object detection mode is configured to output bounding boxes that comprise position information of a golf ball and a hole; and
classifying the bounding boxes to determine positions of the golf ball and hole.

15. A spatial multi-dimensional scanning device, wherein the spatial multi-dimensional scanning device comprises a memory and a processor; the memory is configured to store a computer program; the processor is configured to execute the computer program and implement a path planning method for putting on the green, wherein the method comprises:
scanning a planned green to obtain a spatial multi-dimensional information map of the green;
analyzing the spatial multi-dimensional information map to obtain an elevation information of the green;
performing a target detection on the spatial multi-dimensional information map to determine positions of a golf ball and a hole in the spatial multi-dimensional information map; and
generating a batting path information according to the elevation information and positions of the golf ball and hole, to complete a path planning for the green according to the batting path information.

16. The device according to claim 15, wherein the spatial multi-dimensional scanning device comprises a structured light acquisition module and a visible light acquisition module; the scanning a planned green to obtain a spatial multi-dimensional information map of the green comprises:
obtaining a structured light image of the green scanned and collected by the structured light acquisition module;
obtaining a visible light image of the green scanned and collected by the visible light acquisition module; and
generating the spatial multi-dimensional information map according to the structured light image and the visible light image.

17. The device according to claim 16, wherein the spatial multi-dimensional scanning device further comprises a ranging module; the generating the spatial multi-dimensional information map according to the structured light image and the visible light image comprises:
obtaining a distance information of the green scanned and collected by the ranging module; and
generating the spatial multi-dimensional information map according to the distance information, structured light image and visible light image.

18. The device according to claim 15, wherein the batting path information at least comprises an optimal batting path, the generating a batting path information according to the elevation information and positions of the golf ball and hole comprises:
constructing a digital elevation model of the green according to the elevation information;
setting the position of the golf ball as a starting point and the position of the hole as an end point in the digital elevation model; and
generating the optimal batting path from the starting point to the end point in the digital elevation model according to a preset path planning algorithm.

19. The device according to claim 18, wherein the batting path information further comprises a putting strength; after the generating the optimal batting path from the starting point to the end point in the digital elevation model according to a preset path planning algorithm, the method further comprises:
obtaining a slope information and a friction coefficient corresponding to the optimal batting path in the digital elevation model; and
calculating the putting strength required for the golf ball to roll along the optimal batting path in the digital elevation model according to the slope information and friction coefficient.

20. A computer-readable storage medium, wherein the computer-readable storage medium stores a computer program, the computer program comprises program instructions, when the program instructions are executed by a processor, the processor performs a path planning method for putting on the green according to claim 1.
